(19) United States
(12) Patent Application Publication
(10) Pub. No.: US 2021/0057902 A1
(43) Pub. Date: Feb. 25, 2021

(54) POWER PROTECTION METHOD AND CIRCUIT FOR ELECTRONIC DEVICE

(71) Applicant: GETAC TECHNOLOGY CORPORATION, Hsinchu County (TW)

(72) Inventors: Li-Shing Chen, Taipei City (TW); Yng-Wei Lee, Taipei City (TW)

(21) Appl. No.: 16/550,147

(22) Filed: Aug. 23, 2019

(51) Int. Cl. H02H 3/32; H02H 1/00

(52) U.S. Cl. CPC H02H 3/32; B60R 16/03; H02H 1/0007

(57) ABSTRACT

A power protection method for an electronic device includes supplying power to an electronic device through a power supply path, detecting a positive current of the power path, detecting a negative current of the power path, comparing a current amount of the positive current with a current amount of the negative current, and disconnecting the power path when the current amount of the positive current is not equal to the current amount of the negative current.

### BACKGROUND OF THE INVENTION

### Field of the Invention

The present invention relates to a power supply technology, and more particularly to a power protection method and circuit for an electronic device.

### Description of the Prior Art

Current motor vehicle products differ vastly from conventional applications. A current motor vehicle is equipped with various kinds of in-vehicle electronic devices, one of which is an electronic control device that integrates applications of in-vehicle mechanical systems, for example, engine power, sensor system control and electromechanical control. Another type of the above in-vehicle electronic devices is independently used in a driving environment and is not directly related to the performance, safety or control of the motor vehicle, for example, an audiovisual system, a sound system, a navigation system and a backup/auxiliary camera. Apart from the above, there are numerous in-vehicle electronic devices that can be externally connected to an automobile, for example, a portable electronic device such as a laptop computer and a smartphone.

During the course of driving, power needed for operating these in-vehicles is all provided by battery modules in the motor vehicle. However, due to the large number of in-vehicle electronic devices as well as different powering and grounding means of the in-vehicle electronic devices, imbalance in power loops is often resulted, causing damage or burning of connection wires and/or the in-vehicle electronic devices.

### SUMMARY OF THE INVENTION

In one embodiment, a power protection method for an electronic device includes supplying power to the electronic device through a power path, detecting a positive current of the power path, a detecting a negative current of the power path, comparing a current amount of the positive current with a current amount of the negative current, and disconnecting the power path when the current amount of the positive current is not equal to the current amount of the negative current.

In one embodiment, a power protection circuit for an electronic device includes a positive power terminal, a negative power terminal, a positive load terminal, a negative load terminal, a first power switch, a first detection circuit, a second detection circuit, and a monitoring circuit. The positive power terminal is for coupling to a positive terminal of a power supply. The negative power terminal is for coupling to a negative terminal of the power supply. The positive load terminal and the negative load terminal are for coupling to the electronic device. The positive load terminal and the positive power terminal form a power supply path, and the negative load terminal and the negative power terminal form a power return path. The first power switch is connected in series on the power return path, and is normally in a conducted state. The first detection circuit is coupled to the power supply path, and is for detecting a positive current on the power supply path. The second detection circuit is coupled to the power return path, and is for detecting a negative current on the power return path. The monitoring circuit is coupled to the first power switch, the first detection circuit and the second detection circuit, and is for comparing a current amount of the positive current with a current amount of the negative current. When the current amount of the positive current is not equal to the current amount of the negative current, the monitoring circuit controls the first power switch to be switched to a disconnected state so as to disconnect the power return path.

In conclusion of the above, the power protection method and circuit for an electronic device of any one of embodiments of the present invention is capable of detecting loop imbalance and carrying out corresponding protection measures before a device or a connection wire is damaged.

### BRIEF DESCRIPTION OF THE DRAWINGS

FIG. 1 is a schematic diagram of a power protection circuit for an electronic device according to an embodiment of the present invention;

FIG. 2 is a flowchart of a power protection method for an electronic device according to an embodiment of the present invention;

FIG. 3 is a schematic diagram of a power protection circuit for another electronic device according to an embodiment of the present invention;

FIG. 4 is a flowchart of a power protection method for another electronic device according to an embodiment of the present invention;

FIG. 5 is a brief circuit diagram of a power protection circuit of a first example;

FIG. 6 is a brief circuit diagram of a power protection circuit of a second example;

FIG. 7 is a brief circuit diagram of a power protection circuit of a third example;

FIG. 8 is a brief circuit diagram of a power protection circuit of a fourth example;

FIG. 9 is a brief circuit diagram of a power protection circuit of a fifth example; and

FIG. 10 is a brief circuit diagram of a power protection circuit of a sixth example.

### DETAILED DESCRIPTION OF THE EMBODIMENTS

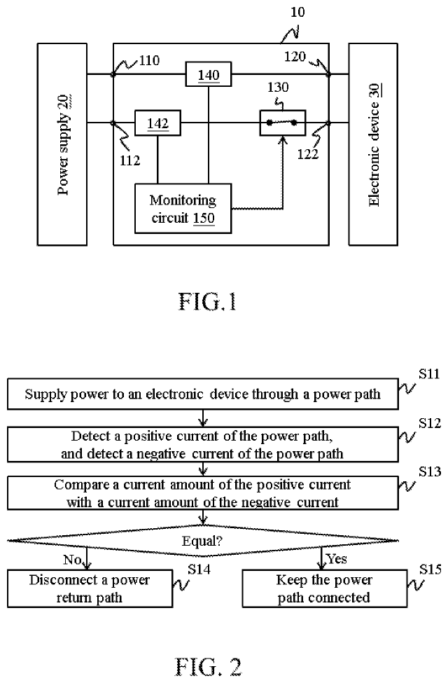

Referring to FIG. 1, a power protection circuit 10 for an electronic device includes a positive power terminal 110, a negative power terminal 112, a positive load terminal 120, a negative load terminal 122, a first power switch 130, a first detection circuit 140, a second detection circuit 142, and a monitoring circuit 150.

The positive power terminal 110 is for coupling to a positive terminal of a power supply 20, and the negative power terminal 112 is for coupling to a negative terminal of the power supply 20. The positive load terminal 120 and the negative load terminal 122 are for coupling to an electronic device 30. In some embodiments, the power supply 20 can be a battery module in a vehicle, and the electronic device 30 can be an in-vehicle electronic device.

The positive load terminal 120 and the positive power terminal 110 form a power supply path. The negative load terminal 122 and the negative power terminal 112 form a power return path. In other words, the power protection circuit 10 provides a power path between the power supply 20 and the electronic device 30, and the power path includes a power supply path and a power return path.

The first power switch 130 is connected in series on the power return path. In other words, the first power switch 130 is coupled between the negative load terminal 122 and the negative power terminal 112.

The first detection circuit 140 is coupled to the power supply path. The second detection circuit 142 is coupled to the power return path. In one embodiment, the first detection circuit 140 and the second detection circuit 142 can be respectively implemented by impedance elements (e.g., resistors and inductors). In other words, the first detection circuit 140 includes an impedance element (to be referred to as a first impedance element). The first impedance element is coupled between the positive power terminal 110 and the positive load terminal 120, i.e., connected in series on the power supply path. The second detection element 142 includes another impedance element (to be referred to as a second impedance element). The second impedance element is coupled between the negative power terminal 112 and the negative load terminal 122, i.e., connected in series on the power return path. The first power switch 130 can be coupled between the second impedance element and the negative power terminal 112, or coupled between the second impedance element and the negative load terminal 122. In another embodiment, the first detection circuit 140 and the second detection circuit 142 can be respectively implemented by transformers. In other words, the first detection circuit 140 includes a transformer (to be referred to as a first transformer). A primary side of the first transformer is coupled between the positive power terminal 110 and the positive load terminal 120, i.e., connected in series on the power supply path. The second detection circuit 142 includes another transformer (to be referred to as a second transformer). A primary side of the second transformer is coupled between the negative power terminal 112 and the negative load terminal 122, i.e., connected in series on the power return path. The first power switch 130 can be coupled between the second transformer and the negative power terminal 112, or coupled between the second transformer and the negative load terminal 122.

The monitoring circuit 150 is coupled to a control terminal of the first power switch 130, an output terminal of the first detection circuit 140, and an output terminal of the second detection circuit 142.

Referring to FIG. 1 and FIG. 2, the first power switch 130 herein is normally in a conducted state. At this point, the power supply 20 can supply power to the electronic device 30 through the power path (i.e., the power supply path and the power return path) (step S11).

The first detection circuit 140 detects a positive current on the power supply path, and provides a current amount of the positive current to the monitoring current 150 (step S12). The second detection circuit 142 detects a negative current on the power return path, and provides a current amount of the negative current to the monitoring circuit 150 (step S12). The monitoring circuit 150 compares the current amount of the positive current with the current amount of the negative current (step S13). When the current amount of the positive current is not equal to the current amount of the negative current, the monitoring circuit 150 controls the first power switch 130 to be switched to a disconnected state, so as to disconnect the power return path (i.e., the power path) (step S14), such that the power supply 20 cannot provide the power needed through the power path for operating the electronic device 30. Conversely, when the current amount of the positive current is equal to the current amount of the negative current, the monitoring circuit 150 keeps the first power switch 130 in the conducted state, that is, keeping the power path connected (step S15), such that the power supply 20 keeps providing the power needed through the power path for operating the electronic device 30.

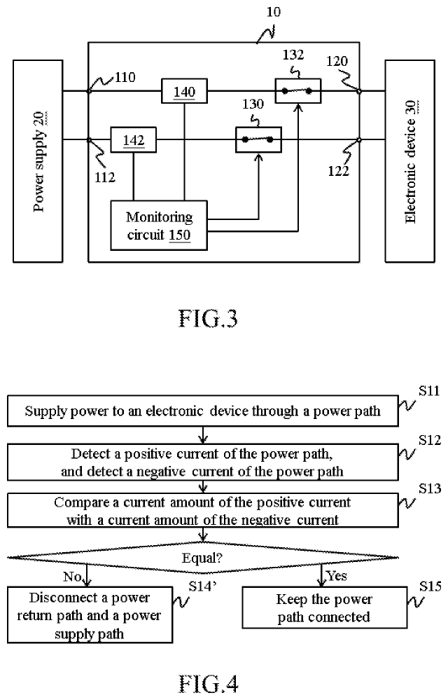

In some embodiments, referring to FIG. 3, the power protection circuit 10 for an electronic device can further include a second power switch 132. The second power switch 132 is connected in series on the power supply path, i.e., coupled between the positive load terminal 120 and the negative power terminal 110. The second power switch 132 is also normally in a conducted state. In other words, in a normal powering state, the first power switch 130 and the second power switch 132 are in a conducted state. Referring to FIG. 3 and FIG. 4, at this point, the power supply 20 supplies power to the electronic device 30 through the power path (i.e., the power supply path and the power return path), the conducted first power switch 130 and the conducted second power switch 132 (step S11). When the current amount of the positive current is not equal to the current amount of the negative current, the monitoring circuit 150 controls the first power switch 130 to be switched to a disconnected state and controls the second power switch 132 to be switched to a disconnected state, so as to simultaneously disconnect the power return path and the power supply path (step S14′). Conversely, when the current amount of the positive current is equal to the current amount of the negative current, the monitoring circuit 150 keeps the first power switch 130 in the conducted state and keeps the second power switch 132 in the conducted state, i.e., keeping the power path connected (step S15). In one embodiment, when the first detection circuit 140 includes the first impedance element, the second power switch 132 can be coupled between the first impedance element and the positive power terminal 110, or coupled between the first impedance element and the positive load terminal 120. In another embodiment, when the first detection circuit 140 includes the first transformer, the second power switch 132 can be coupled between the first transformer and the positive power terminal 110, or coupled between the first transformer and the positive load terminal 120.

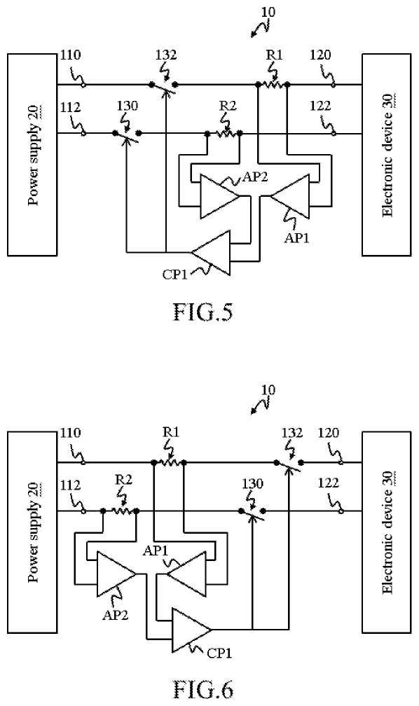

In some embodiments, referring to FIG. 5 and FIG. 6, the first detection circuit 140 includes a resistor R1 (to be referred to as a first resistor R1) and an operational amplifier AP1 (to be referred to as a first operational amplifier AP1). The second detection circuit 142 includes a resistor R2 (to be referred to as a second resistor R2) and an operational amplifier AP2 (to be referred to as a second operational amplifier AP2). The monitoring circuit 150 includes a comparator CP1. Two input terminals of the first operational amplifier AP1 are respectively coupled to two terminals of the first resistor R1, and two input terminals of the second operational amplifier AP2 are respectively coupled to two terminals of the second resistor R2. An output terminal of the first operational amplifier AP1 and an output terminal of the second operational amplifier AP2 are respectively coupled to two input terminals of the comparator CP1. An output terminal of the comparator CP1 is coupled to a control terminal of the first power switch 130 and a control terminal of the second power switch 132.

In a first example, referring to FIG. 5, the first power switch 130 and the second power switch 132 are coupled to a power terminal. In other words, a first terminal of the first power switch 130 is coupled to the negative power terminal 112, and a second terminal of the first power switch 130 is coupled to one terminal of the second resistor R2. The other terminal of the second resistor R2 is coupled to the negative load terminal 122. A first terminal of the second power switch 132 is coupled to the positive power terminal 110, and a second terminal of the second power switch 132 is coupled to one terminal of the first resistor R1. The other terminal of the first resistor R1 is coupled to the positive load terminal 120.

In a second example, referring to FIG. 6, the first power switch 130 and the second power switch 132 are coupled to a load terminal. In other words, the first terminal of the first power switch 130 is coupled to one terminal of the second resistor R2, and the second terminal of the first power switch 130 is coupled to the negative load terminal 122. The other terminal of the second resistor R2 is coupled to the negative power terminal 112. The first terminal of the second power switch 132 is coupled to one terminal of the first resistor R1, and the second terminal of the second power switch 132 is coupled to the positive load terminal 120. The other terminal of the first resistor R1 is coupled to the positive power terminal 110.

The first resistor R1 and the second resistor R2 can have the same resistance value. The first operational amplifier AP1 captures and provides to the comparator CP1 a voltage difference (to be referred to as a first voltage difference) between the two terminals of the first resistor R1. The second operational amplifier AP2 captures and provides to the comparator CP1 a voltage difference (to be referred to as a second voltage difference) between the two terminals of the second resistor R2. The comparator CP1 compares the first voltage difference with the second voltage difference to determine whether the two are equal. According to the Ohm's law, a voltage is directly proportional to a current when a resistance is constant. In other words, when the first resistor R1 and the second resistor R2 have the same resistance value, the first voltage difference being equal to the second voltage difference indicates that the current amount of the positive current passing through the first resistor R1 is equal to the current amount of the negative current passing through the second resistor R2. When the first voltage difference is equal to the second voltage difference, the comparator CP1 outputs a conduction signal to the first power switch 130 and the second power switch 132, so as to keep the first power switch 130 conducted and keep the second power switch 132 conducted. When the first voltage difference is not equal to the second voltage difference, the comparator CP1 outputs a disconnection signal to the first power switch 130 and the second power switch 132, so as to cause the first power switch 130 to become disconnected and cause the second power switch 132 to become disconnected.

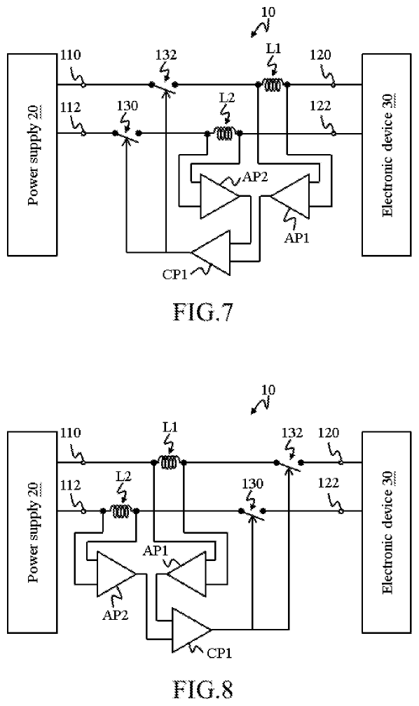

In some embodiments, the first resistor R1 can be replaced by an inductor L1 (to be referred to be a first inductor L1), and the second resistor R2 can be replaced by an inductor L2 (to be referred to as a second inductor L2). Referring to FIG. 7 and FIG. 8, the first detection circuit 140 includes a first inductor L1 and a first operational amplifier AP1. The second detection circuit 142 includes a second inductor L2 and a second operational amplifier AP2. The monitoring circuit 150 includes a comparator CP1. Two input terminals of the first operational amplifier AP1 are respectively coupled to two terminals of the first inductor L1. Two input terminals of the second operational amplifier AP2 are respectively coupled to two terminals of the second inductor L2. An output terminal of the first operational amplifier AP1 and an output terminal of the second operational amplifier AP2 are respectively coupled to two input terminals of the comparator CP1. An output terminal of the comparator CP1 is coupled to a control terminal of the first power switch 130 and a control terminal of the second power switch 132.

In a third example, referring to FIG. 3, the first power switch 130 and the second power switch 132 are coupled to a power terminal. In other words, the first terminal of the first power switch 130 is coupled to the negative power terminal 112, and the second terminal of the first power switch 130 is coupled to one terminal of the second inductor L2. The other terminal of the second inductor L2 is coupled to the negative load terminal 122. The first terminal of the second power switch 132 is coupled to the positive power terminal 110, and the second terminal of the second power switch 132 is coupled to one terminal of the first inductor L1. The other terminal of the first inductor L1 is coupled to the positive load terminal 120.

In a fourth example, referring to FIG. 8, the first power switch 130 and the second power switch 132 are coupled to a load terminal. In other words, the first terminal of the first power switch 130 is coupled to one terminal of the second inductor L2, and the second terminal of the first power switch 130 is coupled to the negative load terminal 122. The other end of the second inductor L2 is coupled to the negative power terminal 112. The first terminal of the second power switch 132 is coupled to one terminal of the first inductor L1, and the second terminal of the second power switch 132 is coupled to the positive load terminal 120. The other terminal of the first inductor L1 is coupled to the positive power terminal 110.

The first inductor L1 and the second inductor L2 can have the same resistance value. The first operational amplifier AP1 captures and provides to the comparator CP1 a voltage difference (to be referred to as a first voltage difference) between the two terminals of the first inductor L1. The second operational amplifier AP2 captures and provides to the comparator CP1 a voltage difference (to be referred to as a second voltage difference) between the two terminals of the second inductor L2. The comparator CP1 compares the first voltage difference with the second voltage difference to determine whether the two are equal. According to the Ohm's law, a voltage is directly proportional to a current when a resistance value is constant. In other words, when the first inductor L1 and the second inductor L2 have the same resistance value, the first voltage difference being equal to the second voltage difference indicates that the current amount of the positive current passing through the first inductor L1 is equal to the current amount of the negative current passing through the second inductor L2. When the first voltage difference is equal to the second voltage difference, the comparator CP1 outputs a conduction signal to the first power switch 130 and the second power switch 132, so as to keep the first power switch 130 conducted and keep the second power switch 132 conducted. When the first voltage difference is not equal to the second voltage difference, the comparator CP1 outputs a disconnection signal to the first power switch 130 and the second power switch 132, so as to cause the first power switch 130 to become disconnected and cause the second power switch 132 to become disconnected.

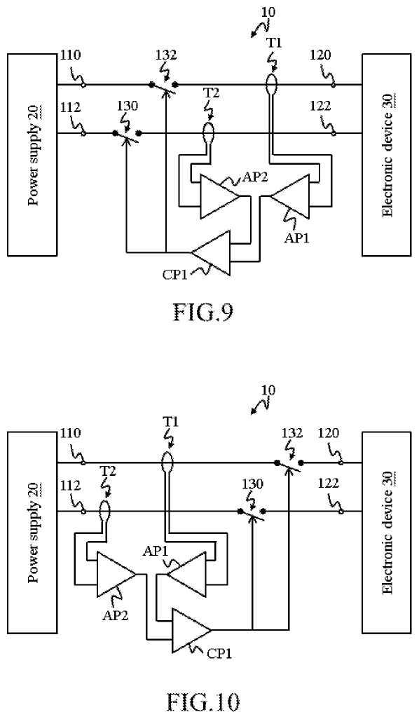

In some embodiments, the first resistor R1 can also be replaced by a transformer T1 (to be referred to as a first transformer T1), and the second resistor R2 can be replaced by a transformer T2 (to be referred to as a second transformer T2). Referring to FIG. 9 and FIG. 10, the first detection circuit 140 includes a first transformer T1 and a first operational amplifier AP1. The second detection circuit 142 includes a second transformer T2 and a second operational amplifier AP2. The monitoring circuit 150 includes a comparator CP1. Two terminals of the first operational amplifier AP1 are respectively coupled to two terminals of a secondary side of the first transformer T1. Two input terminals of the operational amplifier AP2 are respectively coupled to two terminals of a secondary side of the second transformer T2. An output terminal of the first operational amplifier AP1 and an output terminal of the second operational amplifier AP2 are respectively coupled to two input terminals of the comparator CP1. An output terminal of the comparator CP1 is coupled to a control terminal of the first power switch 130 and a control terminal of the second power switch 132.

In a fifth example, referring to FIG. 9, the first power switch 130 and the second power switch 132 are coupled to a power terminal. In other words, the first terminal of the first power switch 130 is coupled to the negative power terminal 112, and the second terminal of the first power switch 130 is coupled to one terminal of a secondary side of the second transformer T2. The other terminal of the secondary side of the second transformer T2 is coupled to the negative load terminal 122. The first terminal of the second power switch 132 is coupled to the positive power terminal 110, and the second terminal of the second power switch 132 is coupled to one terminal of a secondary side of the first transformer T1. The other terminal of the secondary side of the transformer T1 is coupled to the positive load terminal 120.

In a sixth embodiment, referring to FIG. 10, the first power switch 130 and the second power switch 132 are coupled to a load terminal. In other words, the first terminal of the first power switch 130 is coupled to one terminal of the secondary side of the second transformer T2, and the second terminal of the first power switch 130 is coupled to the negative load terminal 122. The other terminal of the secondary side of the second transformer T2 is coupled to the negative power terminal 112. The first terminal of the second power switch 132 is coupled to one terminal of the secondary side of the first transformer T1, and the second terminal of the second power switch 132 is coupled to the positive load terminal 120. The other terminal of the secondary side of the first transformer T1 is coupled to the positive power terminal 110.

The first operational amplifier AP1 senses a current at the secondary side of the first transformer T1 through the two secondary sides of the first transformer T1 to obtain and provide to the comparator CP1 a first current amount. The second operational amplifier AP2 senses a current at the secondary side of the second transformer T2 through the two secondary sides of the second transformer T2 to obtain and provide to the comparator CP1 a second current amount. The comparator CP1 compares the first current amount with the second current amount to determine whether the two are equal. When the first current amount is equal to the second current amount, the comparator CP1 outputs a conduction signal to the first power switch 130 and the second power switch 132, so as to keep the first power switch 130 conducted and keep the second power switch 132 conducted. When the first current amount is not equal to the second current amount, the comparator CP1 outputs a disconnection signal to the first power switch 130 and the second power switch 132, so as to cause the first power switch 130 to become disconnected and cause the second power switch 132 to become disconnected.

In some embodiments, the conduction signal and the disconnection signal can correspond to the switch types of the first power switch 130 and the second power switch 132, and are respectively at a high level and a low level.

In some embodiments, the power protection circuit 10 can be provided in a charging dock. The electronic device 30 can be provided on the charging dock and be electrically connected to internal circuits of the charging dock, so as to be coupled to the power supply 20 through the charging dock. For example, the power supply 20 is a battery module in a vehicle. The interior of the vehicle includes a power connector, which is electrically connected to the battery module. The charging dock includes a first connector and a second connector, and the first connector and the second connector are electrically connected through the internal circuits and the power protection circuit 10. When the electronic device 30 is provided on the charging dock, an electrical connector of the electronic device 30 is coupled to the first connector, so as to have the electronic device 30 be electrically connected to the charging dock. The second connector of the charging dock is coupled to the power connector at the interior of the vehicle through a connecting wire. Therefore, under normal circumstances, the power supply 20 can supply power to the electronic device 30 through the power protection circuit 10.

In some embodiments, the power protection circuit 10 can be provided on a motherboard of a vehicle. The interior of the vehicle includes a power connector, which is electrically connected to a battery module through the power protection circuit 10. At this point, an electrical connector of the electronic device 30 can be coupled to the power connector at the interior of the vehicle through a connection wire or the charging dock. Therefore, under normal circumstances, the power supply 20 can supply power to the electronic device 30 through the power protection circuit 10.

In some embodiments, the interior of a vehicle includes a power connector, and the power protection circuit 10 can be provided in the power connector.

In some embodiments, the abovementioned current amounts (or voltage differences) that are equal means that the two are completely identical, or a difference between the two is within a tolerable range.

In conclusion of the above, the power protection method and circuit for an electronic device of any one of embodiments of the present invention is capable of detecting loop imbalance and carrying out corresponding protection measures before a device or a connection wire is damaged.

What is claimed is:

1. A power protection method for an electronic device, comprising:
supplying power to the electronic device through a power path;
detecting a positive current of the power path;
detecting a negative current of the power path;
comparing a current amount of the positive current with a current amount of the negative current; and
disconnecting the power path when the current amount of the positive current is not equal to the current amount of the negative current.

2. The power protection method for an electronic device according to claim 1, wherein the power path comprises a power supply path transmitting the positive current and a power return path transmitting the negative current, and the step of disconnecting the power path comprises:
disconnecting the power return path.

3. The power protection method for an electronic device according to claim 2, wherein the step of disconnecting the power path further comprises:
disconnecting the power supply path.

4. The power protection method for an electronic device according to claim 1, further comprising:
keeping the power path connected when the current amount of the positive current is equal to the current amount of the negative current.

5. The power protection method for an electronic device according to claim 1, wherein the step of detecting the positive current of the power path comprises capturing the positive current of the power path by an impedance element, and the step of detecting the negative current of the power path comprises capturing the negative current of the power path by another impedance element.

6. The power protection method for an electronic device according to claim 1, wherein the step of detecting the positive current of the power path comprises capturing the positive current of the power path by a transformer, and the step of detecting the negative current of the power path comprises capturing the negative current of the power path by another transformer.

7. A power protection circuit for an electronic device, comprising:
a positive power terminal, for coupling to a positive terminal of a power supply;
a negative power terminal, for coupling to a negative terminal of the power supply;
a positive load terminal, for coupling to the electronic device, wherein the positive load terminal and the positive power terminal form a power supply path;
a negative load terminal, for coupling to the electronic device, wherein the negative load terminal and the negative power terminal form a power return path;
a first power switch, connected in series on the power return path, normally being in a conducted state;
a first detection circuit, coupled to the power supply path, for detecting a positive current on the power supply path;
a second detection circuit, coupled to the power return path, for detecting a negative current on the power return path; and
a monitoring circuit, coupled to the first power switch, the first detection circuit and the second detection circuit, for comparing a current amount of the positive current with a current amount of the negative current; wherein, when the current amount of the positive current is not equal to the current amount of the negative current, the monitoring circuit controls the first power switch to be switched to a disconnected state to disconnect the power return path.

8. The power protection circuit for an electronic device according to claim 7, further comprising:
a second power switch, connected in series on the power supply path, normally being in a conducted state;
wherein, when the current amount of the positive current is not equal to the current amount of the negative current, the monitoring circuit further controls the second power switch to be switched to a disconnected state to disconnect the power supply path.

9. The power protection circuit for an electronic device according to claim 8, wherein when the current amount of the positive current is equal to the current amount of the negative current, the monitoring circuit keeps the power return path connected and keeps the power supply path connected.

10. The power protection circuit for an electronic device according to claim 7, wherein when the current amount of the positive current is equal to the current amount of the negative current, the monitoring circuit keeps the power return path connected.

11. The power protection circuit for an electronic device according to claim 7, wherein the first detection circuit comprises an impedance element connected in series on the power supply path, and the second detection circuit comprises another impedance element connected in series on the power return path.

12. The power protection circuit for an electronic device according to claim 7, wherein the first detection circuit comprises a transformer connected on series on the power supply path, and the second detection circuit comprises another transformer connected in series on the power return path.
